(19) United States
(12) Patent Application Publication
(10) Pub. No.: US 2007/0156345 A1
(43) Pub. Date: Jul. 5, 2007

(54) Modulating a biological recording with another biological recording

(76) Inventors: Roderick A. Hyde, Livermore, CA (US); Edward K. Y. Jung, Bellevue, WA (US); Royce A. Levien, Lexington, MA (US); Robert W. Lord, Seattle, WA (US); Mark A. Malamud, Seattle, WA (US); John D. Rinaldo JR., Bellevue, WA (US); Lowell L. Wood JR., Livermore, CA (US)

Correspondence Address: Searete LLC, Suite 110, 1756 - 114th Ave. S.E., Bellevue, WA, 98004, US

(21) Appl. No.: 11/323,832

(22) Filed: Dec. 30, 2005

(51) Int. Cl. G06F 19/00

(52) U.S. Cl. 702/19

(57) ABSTRACT

A method and system are described for obtaining a signal from a first hair and obtaining a result signal related to the signal from the first hair using a signal from a second hair.

### SUMMARY

An embodiment provides a method. In one implementation, the method includes but is not limited to obtaining a signal from a first hair and obtaining a result signal related to the signal from the first hair using a signal from a second hair. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware configured to effect the herein-referenced method aspects depending upon the design choices of the system designer.

An embodiment provides a system. In one implementation, the system includes but is not limited to circuitry for obtaining a signal from a first hair and a module for obtaining a result signal related to the signal from the first hair using a signal from a second hair. In addition to the foregoing, other system aspects are described in the claims, drawings, and text forming a part of the present disclosure.

In addition to the foregoing, various other embodiments are set forth and described in the text (e.g., claims and/or detailed description) and/or drawings of the present description.

The foregoing is a summary and thus contains, by necessity, simplifications, generalizations and omissions of detail; consequently, those skilled in the art will appreciate that the summary is illustrative only and is not intended to be in any way limiting. Other aspects, features, and advantages of the devices and/or processes described herein, as defined by the claims, will become apparent in the detailed description set forth herein.

### BRIEF DESCRIPTION OF THE FIGURES

FIG. 1 depicts an exemplary environment in which one or more technologies may be implemented.

FIG. 2 shows a highly magnified view of three similar-looking hairs.

FIG. 3 shows a high-level logic flow of an operational process.

FIG. 4 shows plots of several functions of distance and time.

FIG. 5 shows several variants of the flowchart of FIG. 3.

FIG. 6 shows several variants of the flowchart of FIG. 3 or 5.

FIG. 7 shows several variants of the flowchart of FIG. 3, 5, or 6.

FIG. 8 shows several variants of the flowchart of FIG. 3, 5, 6, or 7.

FIG. 9 shows several variants of the flowchart of FIG. 3, 5, 6, 7, or 8.

### DETAILED DESCRIPTION

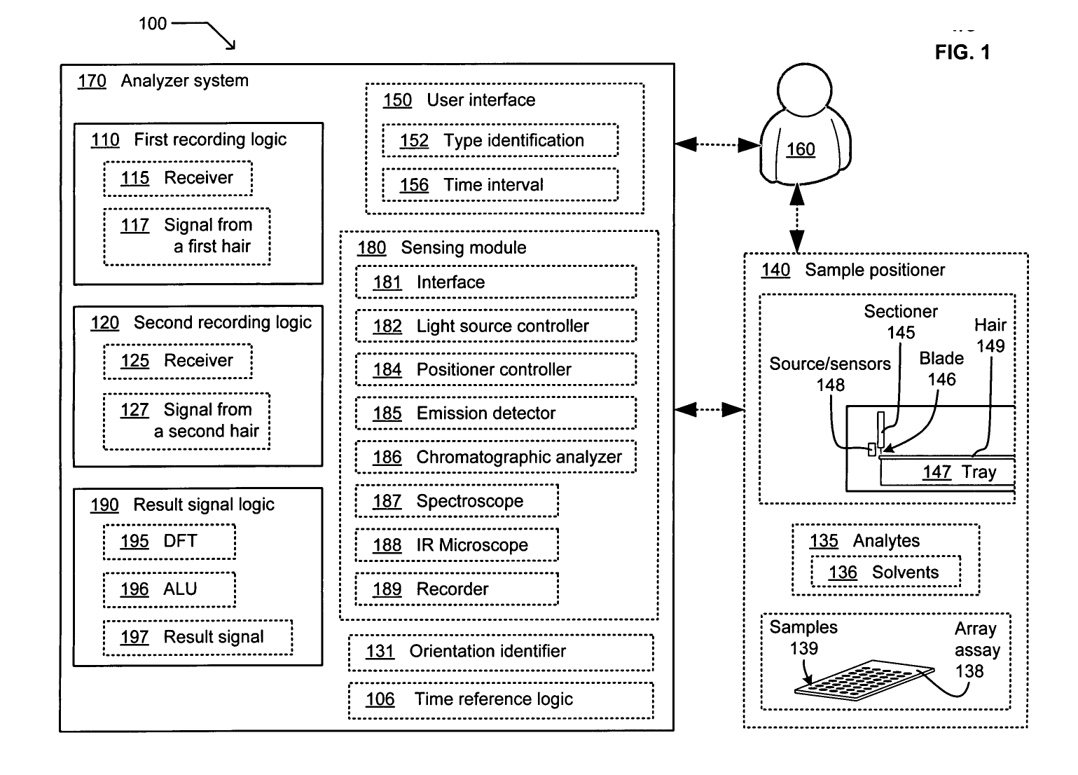

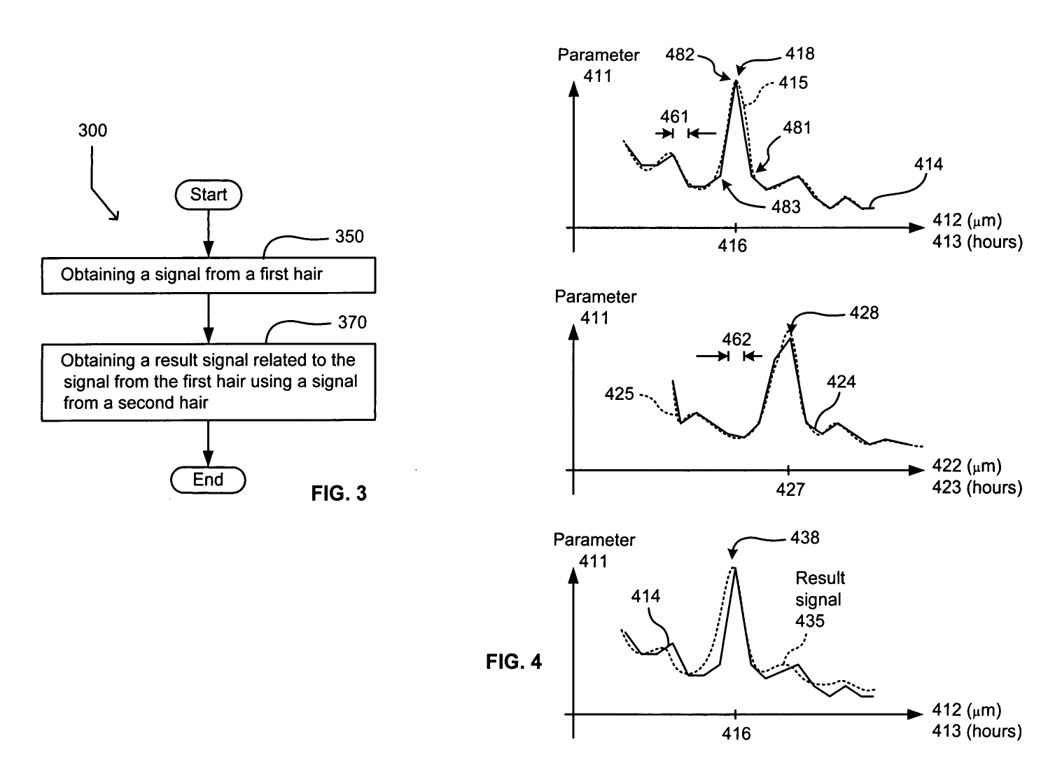

FIG. 1 depicts an exemplary environment in which one or more technologies may be implemented. Lab system 100 includes analyzer system 170, and may include sample positioner 140 also, operable by user 160. Analyzer system 170 includes first recording logic 110, second recording logic 120, and result signal logic 190. First recording logic 110 may include one or more of receiver 115 or signal 117 from a first hair. Second recording logic 120 may likewise include one or more of receiver 125 or signal 127 from a second hair (as will be explained with reference to FIGS. 3 & 5, for example). Result signal logic 190 may include one or more of Discrete Fourier Transform (DFT) 195, Arithmetic Logic Unit (ALU) 196, or result signal 197.

Any of signal 117, signal 127, or result signal 197 can optionally be analog or digital, scalar- or matrix-valued, and may be buffered, stored, or merely transmitted. Moreover result signal 197 may comprise an array of stored values, a message, a control signal, a historical record, or simply an XY-plot or other outcome presented to user 160 via user interface 150.

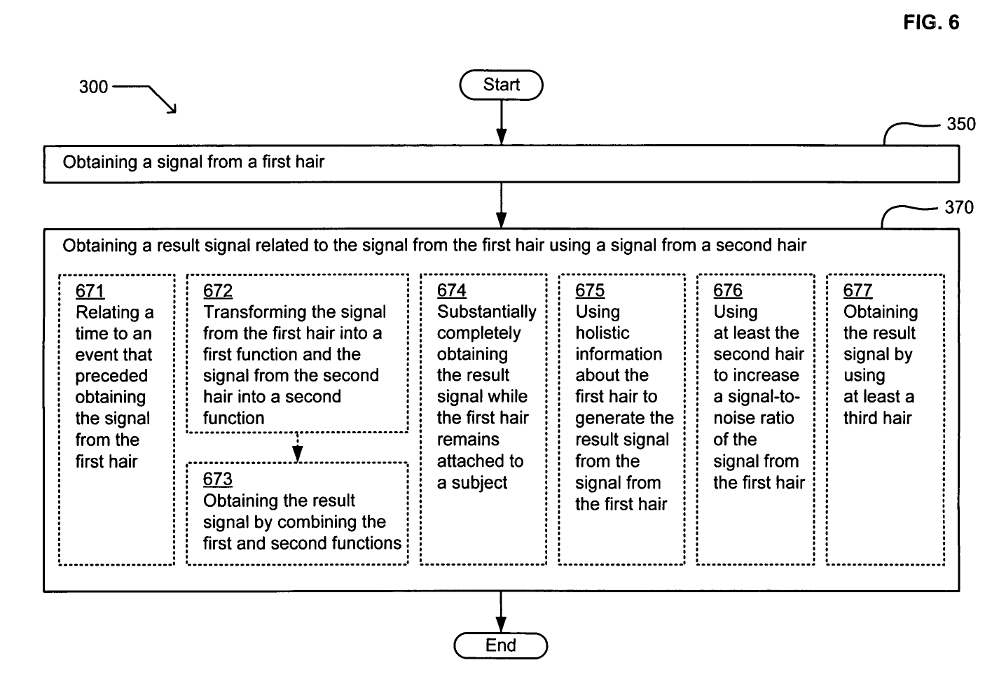

Analyzer system 170 may also include one or more of time reference logic 106, orientation identifier 131, user interface 150, or sensing module 180. User interface 150 may include one or more of type identification 152 or time interval 156, as described below with reference to FIGS. 6 & 9 respectively.

Sensing module 180 may include one or more of light source controller 182, positioner controller 184, emission detector 185, chromatographic analyzer 186, spectroscope 187, IR microscope 188, or recorder 189. Alternatively or additionally, sensing module can include interface 181 operable to transmit signal 117 to receiver 115 or to transmit signal 127 to receiver 125. For example, interface 181 can optionally be operable to control or otherwise obtain these signals from one or more network-accessible, remote, or other external systems such as an analyzer, a spectroscope, a microscope, or a computing system.

Sample positioner 140 optionally includes one or more of solvents 136 or other analytes 135, array assays 138 containing samples 139, or sectioner 145. As shown in relation to sectioner 145, source/sensors 148 can optionally be included to measure one or more optical responses of a left-most end of hair 149 to a controlled emission from source/sensors 148. As shown, sectioner 145 is controllable to manipulate blade 146 to cut hair 149 very precisely, such as by actuating blade 146 with one or more piezo stacks or MEMS devices (not shown). In this optional example, tray 147 is similarly controllable to translate left (carrying hair 149) or otherwise to push hair 149 left very precisely for further cuttings or measurements, such as by using a stepper motor (not shown). Those skilled in the art can readily implement sectioner 145 with other cutting mechanisms as well, such as a laser or a fine grinding surface. Sectioner 145 can alternatively be implemented as a row or other array of cells each containing a solvent into which an end of hair 149 is dipped (array assay 138, e.g.).

It is contemplated that some embodiments of lab system 100 include sample positioner 140, as indicated by its dashed border, and that some do not. For example, samples and/or signals may be received directly in some embodiments of analyzer system 170, in which case lab system 100 can function well even without sample positioner 140.

In some embodiments involving sectioner 145, however, tray 147 can move hair 149 left so far that it extends well beyond source/sensors 148, after which source/sensors 148 can optionally be used for measuring one or more optical properties of a lateral surface of hair 149. In a variant configuration (not shown), a similar configuration of one or more lasers and one or more sensors are positioned “upstream” from sectioner 145 relative to the (leftward) motion of hair 149.

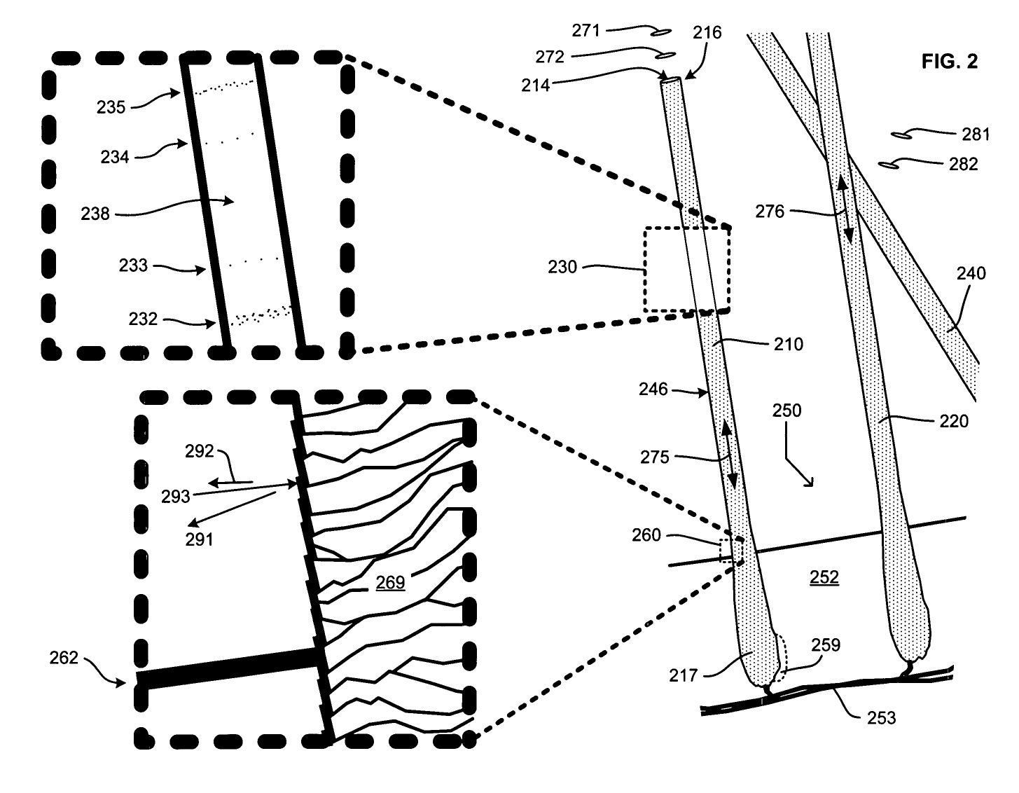

Turning now to FIG. 2, there is shown a highly magnified view of three similar-looking hairs 210, 220, and 240, two of which remain affixed with skin 252 of subject 250 as shown. First hair 210 is substantially aligned along axis 275 within a range of interest longer than 0.5 mm, and second hair 220 is substantially aligned along parallel axis 276 within its (shown) range of interest.

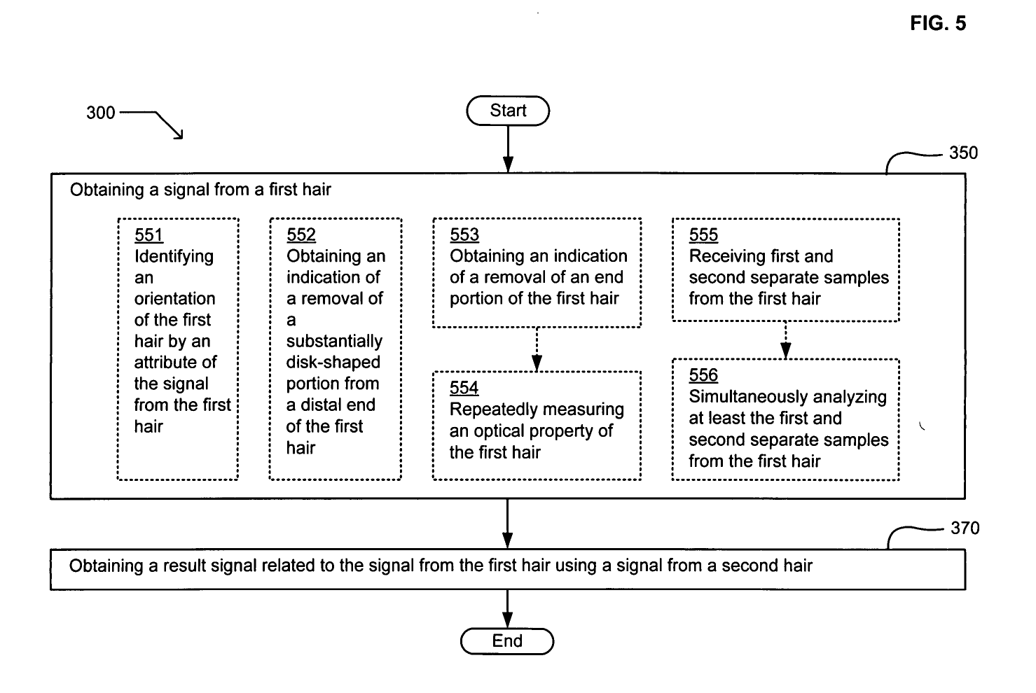

Blood vessel 253 nourishes first hair 210 at root 217. Root 217 is the most extreme proximal portion of hair 210, and is also firmly attached to skin tag 259, which can be useful as explained below in relation to FIG. 5. As shown, portion 271 and portion 272 have been removed from the distal portion of hair 210, which includes surface 214 at end 216.

As described below, some embodiments relate to one or more second hairs, which can comprise hair 220 and/or hair 240. Portions 281 and 282, as explained below, are samples from an end of the second hair. In some embodiments it is not initially known whether the portions 281 & 282 are from a distal or proximal end of the second hair.

Referring again to first hair 210, a more magnified view of longitudinal portion 230 is provided. At least sebum layer 246 has been removed from longitudinal portion 230, revealing lateral surface 238, a cortex surface. Even without dissolving the cortex of longitudinal portion 230, as described below, it may be possible to detect one or more of first marker 232, naturally-occurring marker 233, impurity 234, or artificial marker 235.

FIG. 2 also provides an even more magnified view of lateral portion 260 of first hair 210 at skin line 262. That magnified view clearly shows how sebum layer 246 comprises outward-tilting plates 269 that can help establish an orientation of hair 240, for example. The plates are optically assymetrical, so that for example, incident light 293 substantially perpendicular to axis 275 is reflected along ray 291 more than along ray 292. This is one of the inherent assymetries enabling orientation identifier 131 to function, for example.

Referring now to FIG. 3, there is shown a high-level logic flow 300 of an operational process. Operation 350 shows obtaining a signal from a first hair (e.g., first recording logic 110 obtaining signal 117 from first hair 210). In some embodiments, signal 117 is obtained from more than one hair. See, e.g., FIG. 6. In some embodiments, sample positioner 140 of FIG. 1 can hold first hair 210 of FIG. 2 in situ while sensing module 180 collects data. In some embodiments, as described below, one or more of time reference logic 106, orientation identifier 131, user interface 150, or sensing module 180 cooperate with first recording logic 110 to perform operation 350.

Operation 370 shows obtaining a result signal related to the signal from the first hair using a signal from a second hair (e.g., result signal logic 190 and second recording logic 120 obtaining result signal 197 related to signal 117 using signal 127 from second recording logic 120). In some embodiments, second recording logic 120 obtains signal 127 from more than one hair. In some embodiments, as described below, one or more of time reference logic 106, orientation identifier 131, user interface 150, or sensing module 180 cooperate with result signal logic 190 to perform operation 370.

Referring now to FIG. 4, there is shown a segmented plot of parameter 411 as a function 414 of distance 412. Parameter 411 can be a concentration, a radioactivity, a luminescence, a magnetic response, an electrical resistance or capacitance, a reactivity with an analyte, a bacteria concentration, a temperature, or substantially any axially variable, measurable or calculable quantity. Assuming a substantially steady hair growth rate, function 414 adequately represents parameter 411 plotted versus time 413 as well. In any case, function 414 comprises a series of samples 481, 482, and 483 having a uniform horizontal increment 461; a peak 418 (i.e. sample 482) at position 416; and older, more distal samples to the right of position 416.

FIG. 4 also shows a segmented plot of parameter 411 as another function 424 of distance 422 and time 423, having a regular increment 462. Function 424 is derived from a different (second) hair not perfectly aligned with the first hair. Because of this difference, for example, function 424 has a peak 428 at location 427, not aligned with position 416.

This offset can be reduced by moving function 424 leftward so that it aligns better with function 414, such as by offsetting function 424 by the horizontal difference between location 427 and position 416. Those skilled in the art will recognize there are a variety of other ways as well, such as by offsetting function 424 leftward by an amount that minimizes a cumulative expression of differences (by the method of least squares, e.g.) between function 424 and 414. Yet another method is described below in relation to FIG. 6, one that involves combining frequency-transformed functions 415 and 425 to generate result signal 435. Result signal 435 accurately depicts a peak value 438 of parameter 411 occurring to the left of peak 418, signifying a newer and more proximal marker in the first hair than could be gleaned by the first-hair data alone. More generally, result signal 435 has a lower, more desirable actual or expected signal-to-noise ratio (SNR) than function 414.

Referring now to FIG. 5, there are shown several variants of the flow 300 of FIG. 3. Operation 350—obtaining a signal from a first hair—may include one or more of the following operations: 551, 552, 553, 554, 555, or 556. Operation 551 depicts identifying an orientation of the first hair by an attribute of the signal from the first hair (e.g., orientation identifier 131 specifying “forward” at least partly based on a decreasing trend in a function 424 indicative of a lipid density, in that lipid density tends to decrease as a hair segment ages). In some embodiments, an orientation identifier has a value of “right side up,” “distal,” “proximal,” “opposite,” “older,” “toward the root,” “true,” “false,” or some other indicator describing which end of a sample or signal is which. In some embodiments, orientation identifier 131 operates by determining whether light 293 orthogonally approaching axis 275 of hair 210 primarily reflects as first ray 291 in a first direction or second ray 292 in a second direction. In some embodiments, user 160 is able to set or override an orientation identifier 131 if signal 117 includes a two-dimensional image indicating a skin tag 259, a bulbous root 217, or a clear image of plates 269.

Operation 552 depicts obtaining an indication of a removal of a substantially disk-shaped portion from a distal end of the first hair (e.g., positioner controller 184 receiving an indication that sectioner 145 removed a disk-shaped portion like portion 282 from a left-most end of hair 149). In some embodiments, what is obtained is an indication that what was an oblong-disk-shaped cross section of a curly hair has been dissolved by one or more solvents 136 or is otherwise in a chemically altered form. In some instances, also, “substantially disk-shaped” portions can be about as long as they are in diameter.

Operation 553 depicts obtaining an indication of a removal of an end portion of the first hair (e.g., positioner controller 184 receiving an indication that sectioner 145 has removed an end portion of hair 149). In some embodiments, successive end portions are numbered sequentially (as samples 139 in array assay 138, e.g.), which are then analyzed to generate successive values (such as samples 481, 482, & 483) of a parameter.

Operation 554 depicts repeatedly measuring an optical property of the first hair (e.g., emission detector 185 repeatedly measuring gloss or redness of hair 149 via source/sensors 148 as tray 147 advances leftward). In some embodiments, source/sensors 148 is oriented to target substantially an end surface of hair 149 responsive to operation 553.

Operation 555 depicts receiving first and second separate samples from the first hair (e.g., chromatographic analyzer 186 receiving array assay 138 containing samples 139 from hair 149). In some embodiments, the first sample is formed by combining portions from two hairs (combining portion 271 with portion 281, e.g.) and the second sample is also formed by combining portions from two hairs (combining portion 272 with portion 282, e.g.). This exemplifies embodiments in which more than one first hair is used to obtain the first sample, such as by physically aligning two or more parallel strands with a comb, or with reference to a marker impurity in each. In some embodiments this technique can be used for obtaining larger sample amounts when the alignment among the first hairs is kept sufficiently accurate.

Operation 556 depicts simultaneously analyzing at least the first and second separate samples from the first hair (e.g., chromatographic analyzer 186 analyzing the above-references samples 139 in a synchronized or other simultaneous fashion). In some embodiments, array assay 138 holds the samples in separate cells while exposing both (or all) to one or more analytes 135.

Referring now to FIG. 6, there are shown several variants of the flow 300 of FIG. 3 or 5. Operation 370—obtaining a result signal related to the signal from the first hair using a signal from a second hair—may include one or more of the following operations: 671, 672, 673, 674, 675, 676, or 677. Operation 671 depicts relating a time to an event that preceded obtaining the signal from the first hair (e.g., time reference logic 106 indicating when a marker was injected or ingested). In some embodiments, the event can be an absorption such as a hair dye or bleach being externally applied to the first and second hairs down to a hairline. In some embodiments, the event can be an explosion or an exposure to a radioactive material. In some embodiments, time reference logic 106 contains a calendar date or a number of hours that is used to obtain or display result signal 197.

Operation 672 depicts transforming the signal from the first hair into a first function and the signal from the second hair into a second function (e.g., DFT 195 transforming signal samples comprising functions 414 & 424 into continuous functions 415 & 425, respectively). Alternatively or additionally, ALU 196 applies a scaling function or other linear function to a signal that is expressed as a length so that the first function or the result function can be expressed as a function of time, as exemplified in the model of FIG. 4. Those skilled in the art will recognize a wide variety of frequency transformations, digital transformations, offset transformations, continuous transformations, and other transformations available for performing operation 672.

Operation 673 depicts obtaining the result signal by combining the first and second functions (e.g., ALU 196 generating result signal 197 by averaging or otherwise arithmetically combining first function 415 with at least second function 425).

Operation 674 depicts substantially completely obtaining the result signal while the first hair remains attached to a subject (e.g., first recording logic 110 obtaining signal 117 from at least first hair 210, and result signal logic 190 generating result signal 197, while first hair 210 remains in situ). In some embodiments, first recording logic 110 can obtain thousands of samples comprising signal 117 while a comb allows first hair 210 to slide along emission detector 185. In some embodiments, sample positioner 140 can likewise comprise a brush, or roller, for example, that controls the position of first hair 210 without detaching first hair 210 from subject 250. With or without sample positioner 140, emission detector 185 can work in concert with light source controller 182, in some embodiments, collecting signal 117 from at least first hair 210 like a bar code reader.

Operation 675 depicts using holistic information about the first hair to generate the result signal from the signal from the first hair (e.g., ALU 196 and time reference logic 106 scaling signal 117 partly based on type identification 152 of “8-year-old” relating to a child or other animal from which hair 149 was obtained). In some embodiments, the holistic information includes information input via user interface 150 that does not explicitly describe any subject, but instead indicates (a) a head or other body part from which the first hair grew, for example, or (b) a “gray” color or “terminal hair” type.

Operation 676 depicts using at least the second hair to increase a signal-to-noise ratio of the signal from the first hair. In some embodiments, second recording logic 120 receives data from spectroscope 187 about a chronological series of samples from hair 220. Result signal logic 190 can perform operation 370 by combining signal 117 with this chronological series to generate result signal 197 having a higher signal-to-noise ratio than signal 117, in some embodiments, by virtue of using hair 220.

Operation 677 depicts obtaining the result signal by using at least a third hair (e.g., first recording logic 110 obtaining data from sensing module 180 analyzing a combined sample that includes portions from several strands). In some embodiments, the strands are carefully aligned using an optically detectable marker before segmenting, enhancing the SNR by reducing misalignment-induced error.

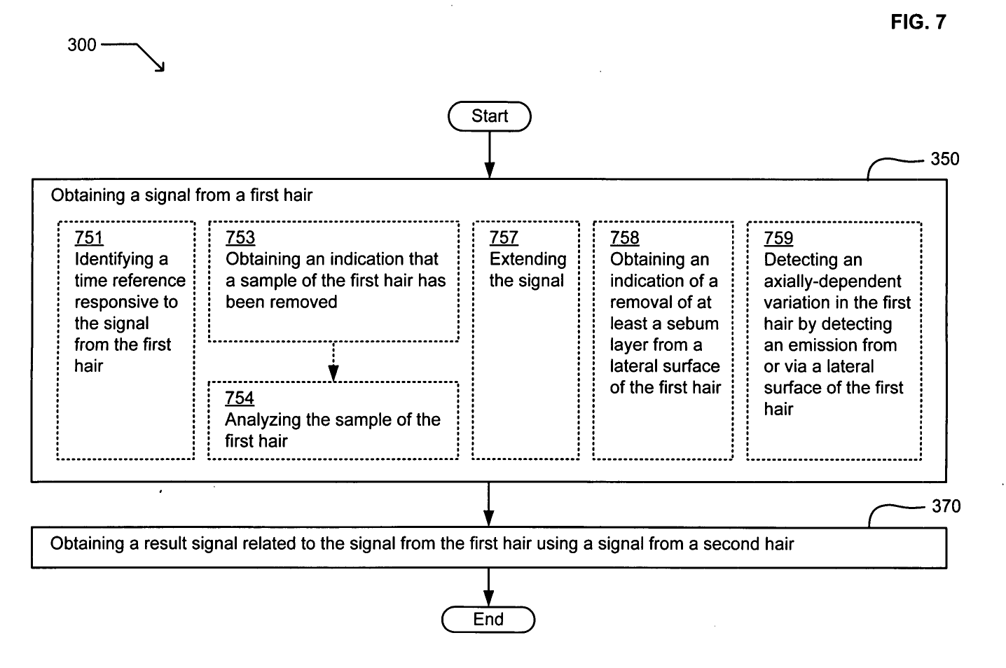

Referring now to FIG. 7, there are shown several variants of the flow 300 of FIG. 3, 5, or 6. Operation 350—obtaining a signal from a first hair—may include one or more of the following operations: 751, 753, 754, 757, 758, or 759. Operation 751 depicts identifying a time reference responsive to the signal from the first hair (e.g., time reference logic 106 establishing a position on or in hair 210 responsive to detecting a peak 418 in function 414). In some embodiments, a dye or bleach transition or cut across hair 210 establishes a visible time reference at skin line 262 corresponding to a current instant. In some embodiments, the time reference is offset from any visible feature or other signal anomaly using a growth model such as an assumption that hair 210 grows at 600 micrometers per day.

Operation 753 depicts obtaining an indication that a sample of the first hair has been removed (e.g., sensing module 180 receiving array assay 138 containing samples 139 from the first hair). In some embodiments, operation 753 defines a remainder of the first hair, such as when one or more solvents 136 expose end surface 214 of hair 210 by removing portion 272, leaving a remainder of first hair 210.

Operation 754 depicts analyzing the sample of the first hair (e.g., by synchrotron-based infrared microscope 188 obtaining one or more images of samples 139 from hair 149). In other embodiments, operation 754 includes spectroscope 187 generating signal 117 by measuring one or more color attributes of a portion of end surface 214.

Operation 757 depicts extending the signal (e.g., first recording logic 110 appending samples onto signal 117 after receiving them via receiver 115).

Operation 758 depicts obtaining an indication of a removal of at least a sebum layer from a lateral surface of the first hair (e.g., positioner controller 184 receiving such an indication from sample positioner 140, indicating that an abrading process or one or more solvents 136 have exposed lateral surface 238 by disintegrating at least sebum layer 246 at longitudinal portion 230 of hair 210).

Operation 759 depicts detecting an axially-dependent variation in the first hair by detecting an emission from or via a lateral surface of the first hair (e.g., emission detector 185 detecting impurity 234 as a radioactive emission pulse sensed while sliding up lateral surface 238 along axis 275).

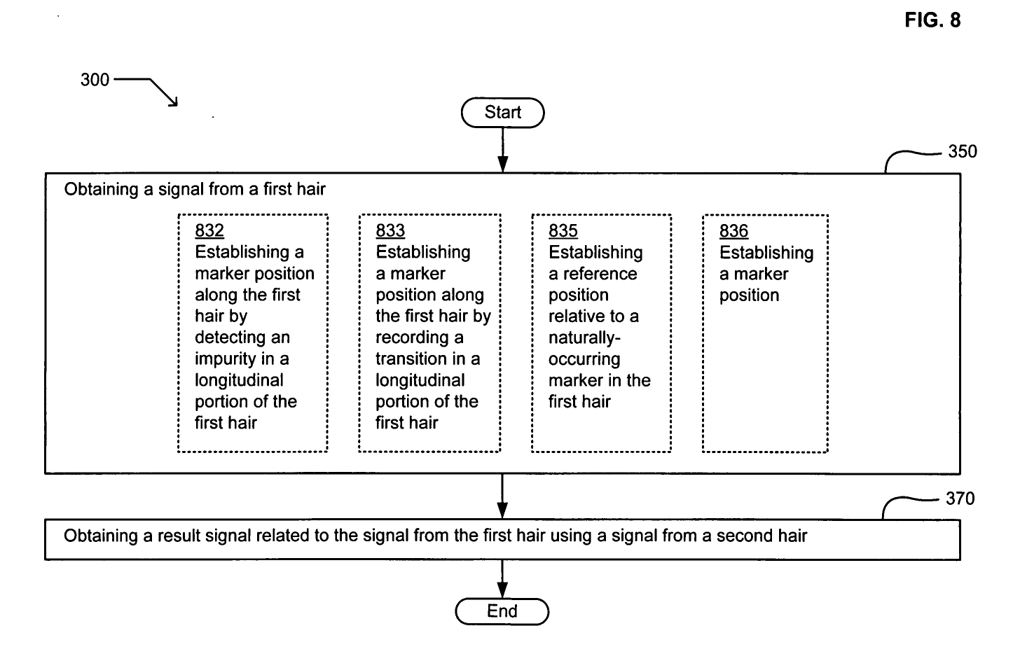

Referring now to FIG. 8, there are shown several variants of the flow 300 of FIG. 3, 5, 6, or 7. Operation 350—obtaining a signal from a first hair—may include one or more of the following operations: 832, 833, 835, or 836. Any of these operations may, in various embodiments, be triggered or acted upon by first recording logic 110.

Operation 832 depicts establishing a marker position along the first hair by detecting an impurity in a longitudinal portion of the first hair (e.g., emission detector 185 establishing that impurity 234 is a marker within longitudinal portion 230 of first hair 210).

Operation 833 depicts establishing a marker position along the first hair by recording a transition in a longitudinal portion of the first hair (e.g., recorder 189 recording and retrieving data indicating a large increase in parameter 411 between sample 481 and sample 482, and time reference logic 106 responding to the large increase by establishing a marker at position 416). In some embodiments, a marker position is visually established. In other embodiments, the marker position is established by identifying one or more successive samples that constitute the transition (at which time the samples may be dissolved, disintegrated, or destroyed).

Operation 835 depicts establishing a reference position relative to a naturally-occurring marker in the first hair (e.g., result signal 197 indicating that first marker 232 is longitudinally offset from naturally-occurring marker 233 by about 70 microns).

Operation 836 depicts establishing a marker position (e.g., result signal 197 indicating a physical position of first marker 232, naturally-occurring marker 233, impurity 234, or artificial marker 235).

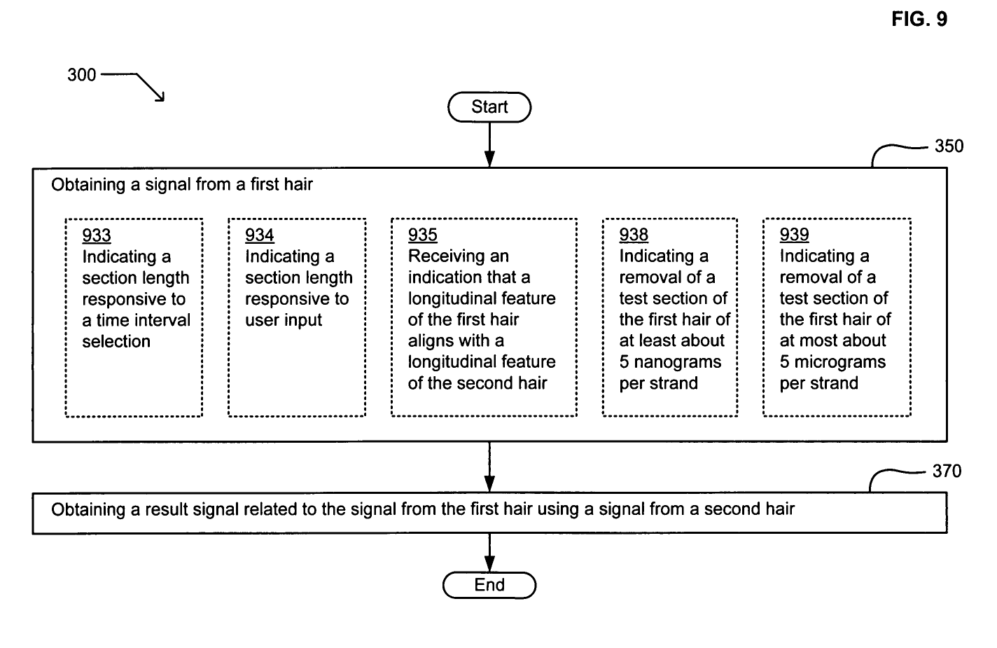

Referring now to FIG. 9, there are shown several variants of the flow 300 of FIG. 3, 5, 6, 7, or 8. As shown in FIG. 9, operation 350—obtaining a signal from a first hair—may include one or more of the following operations: 933, 934, 935, 938, or 939. Any of these operations may, in various embodiments, be triggered or acted upon by first recording logic 110.

Operation 933 depicts indicating a section length responsive to a time interval selection (e.g., positioner controller 184 specifying a section length range of 10 μm±0.3 μm responsive to an indication of “short” from user 160 for time interval 156). In some embodiments, the section length also depends on other inputs via user interface 150 such as “liquid chromatography” as a selected analysis type.

Operation 934 depicts indicating a section length responsive to user input (e.g., user interface 150 indicating a default section length of 10 μm responsive to user 160 selecting a menu option of “show defaults”). In some embodiments, sensing module causes sectioner 145 to section first hair 210 into several substantially uniform 1 μm samples substantially corresponding to a user-specified time interval 156. In other embodiments, user 160 can confirm or change a section length to be passed from positioner controller 184 to sample positioner 140. In some embodiments, analyzer system 170 lacks a direct coupling to sample positioner 140, but user interface 150 can provide user 160 with a feasible section length upon request, for user to implement via sample positioner 140.

Operation 935 depicts receiving an indication that a longitudinal feature of the first hair aligns with a longitudinal feature of the second hair (e.g., positioner controller 184 receiving an indication that sample positioner 140 contains at least the first and second hairs positioned substantially in parallel and a bleaching transition of each lying substantially along a line perpendicular to the hairs). In some embodiments, operation 935 is performed by aligning the hairs by their ends (as the longitudinal features) formed by cutting with a razor or scissors (not shown).

Operation 938 depicts indicating a removal of a test section of the first hair of at least about 5 nanograms per strand (e.g., positioner controller 184 instructing that sectioner 145 or solvents 136 remove a substantially disk-shaped or other portion at least about 1 micron long).

Operation 939 depicts indicating a removal of a test section of the first hair of at most about 5 micrograms per strand (e.g., positioner controller 184 instructing that sectioner 145 or solvents 136 remove a substantially disk-shaped or other portion at most about 1 mm in length). Additional “first” hairs can be aligned, similarly sectioned, and added, in some embodiments, to achieve a desired mass per sample without a loss of temporal resolution.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

While particular aspects of the present subject matter described herein have been shown and described, it will be apparent to those skilled in the art that, based upon the teachings herein, changes and modifications may be made without departing from this subject matter described herein and its broader aspects and, therefore, the appended claims are to encompass within their scope all such changes and modifications as are within the true spirit and scope of this subject matter described herein. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Moreover, “can” and “optionally” and other permissive terms are used herein for describing optional features of various embodiments. These terms likewise describe selectable or configurable features generally, unless the context dictates otherwise.

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable and/or physically interacting components and/or wirelessly.

1. A method comprising:
obtaining a signal from a first hair; and
obtaining a result signal related to the signal from the first hair using a signal from a second hair.

2. (canceled)

3. (canceled)

4. The method of claim 1, wherein obtaining a signal from a first hair comprises:
obtaining an indication of a removal of an end portion of the first hair; and
repeatedly measuring an optical property of the first hair.

5. (canceled)

6. The method of claim 1, wherein obtaining a result signal related to the signal from the first hair using a signal from a second hair comprises:
relating a time to an event that preceded obtaining the signal from the first hair.

7. (canceled)

8. The method of claim 1, wherein obtaining a result signal related to the signal from the first hair using a signal from a second hair comprises:
substantially completely obtaining the result signal while the first hair remains attached to a subject.

9. (canceled)

10. The method of claim 1, wherein obtaining a result signal related to the signal from the first hair using a signal from a second hair comprises:
using at least the second hair to increase a signal-to-noise ratio of the signal from the first hair.

11. (canceled)

12. (canceled)

13. The method of claim 1, wherein obtaining a signal from a first hair comprises:
obtaining an indication that a sample of the first hair has been removed; and analyzing the sample of the first hair.

14. (canceled)

15. The method of claim 1, wherein obtaining a signal from a first hair comprises:
obtaining an indication of a removal of at least a sebum layer from a lateral surface of the first hair.

16. (canceled)

17. (canceled)

18. (canceled)

19. The method of claim 1, wherein obtaining a signal from a first hair comprises:
establishing a reference position relative to a naturally-occurring marker in the first hair.

20. (canceled)

21. The method of claim 1, wherein obtaining a signal from a first hair comprises:
indicating a section length responsive to a time interval selection.

22. The method of claim 1, wherein obtaining a signal from a first hair comprises:
indicating a section length responsive to user input.

23. (canceled)

24. (canceled)

25. (canceled)

26. A system comprising:
means for obtaining a signal from a first hair; and
means for obtaining a result signal related to the signal from the first hair using a signal from a second hair.

27. The system of claim 26, wherein the means for obtaining a signal from a first hair comprises:
means for identifying an orientation of the first hair by an attribute of the signal from the first hair.

28. The system of claim 26, wherein the means for obtaining a signal from a first hair comprises:
means for obtaining an indication of a removal of a substantially disk-shaped portion from a distal end of the first hair.

29. (canceled)

30. The system of claim 26, wherein the means for obtaining a signal from a first hair comprises:
means for receiving first and second separate samples from the first hair; and
means for simultaneously analyzing at least the first and second separate samples from the first hair.

31. The system of claim 26, wherein the means for obtaining a result signal related to the signal from the first hair using a signal from a second hair comprises:
means for relating a time to an event that preceded obtaining the signal from the first hair.

32. (canceled)

33. (canceled)

34. (canceled)

35. (canceled)

36. (canceled)

37. (canceled)

38. The system of claim 26, wherein the means for obtaining a signal from a first hair comprises:
means for obtaining an indication that a sample of the first hair has been removed; and means for analyzing the sample of the first hair.

39. (canceled)

40. (canceled)

41. The system of claim 26, wherein the means for obtaining a signal from a first hair comprises:
means for detecting an axially-dependent variation in the first hair by detecting an emission from or via a lateral surface of the first hair.

42. The system of claim 26, wherein the means for obtaining a signal from a first hair comprises:
means for establishing a marker position along the first hair by detecting an impurity in a longitudinal portion of the first hair.

43. The system of claim 26, wherein the means for obtaining a signal from a first hair comprises:
means for establishing a marker position along the first hair by recording a transition in a longitudinal portion of the first hair.

44. (canceled)

45. The system of claim 26, wherein the means for obtaining a signal from a first hair comprises:
means for establishing a marker position.

46. (canceled)

47. The system of claim 26, wherein the means for obtaining a signal from a first hair comprises:
means for indicating a section length responsive to user input.

48. (canceled)

49. (canceled)

50. (canceled)

51. A system comprising:
circuitry for obtaining a signal from a first hair; and
circuitry for obtaining a result signal related to the signal from the first hair using a signal from a second hair.

52. The system of claim 51, wherein the circuitry for obtaining a signal from a first hair comprises:
circuitry for identifying an orientation of the first hair by an attribute of the signal from the first hair.

53. The system of claim 51, wherein the circuitry for obtaining a signal from a first hair comprises:
circuitry for obtaining an indication of a removal of a substantially disk-shaped portion from a distal end of the first hair.

54. The system of claim 51, wherein the circuitry for obtaining a signal from a first hair comprises:
circuitry for obtaining an indication of a removal of an end portion of the first hair; and circuitry for repeatedly measuring an optical property of the first hair.

55. (canceled)

56. The system of claim 51, wherein the circuitry for obtaining a result signal related to the signal from the first hair using a signal from a second hair comprises:
circuitry for relating a time to an event that preceded obtaining the signal from the first hair.

57. The system of claim 51, wherein the circuitry for obtaining a result signal related to the signal from the first hair using a signal from a second hair comprises:
circuitry for transforming the signal from the first hair into a first function and the signal from the second hair into a second function; and
circuitry for obtaining the result signal by combining at least the first and second functions.

58. The system of claim 51, wherein the circuitry for obtaining a result signal related to the signal from the first hair using a signal from a second hair comprises:
circuitry for substantially completely obtaining the result signal while the first hair remains attached to a subject.

59. The system of claim 51, wherein the circuitry for obtaining a result signal related to the signal from the first hair using a signal from a second hair comprises:
circuitry for using holistic information about the first hair to generate the result signal from the signal from the first hair.

60. The system of claim 51, wherein the circuitry for obtaining a result signal related to the signal from the first hair using a signal from a second hair comprises:
circuitry for using at least the second hair to increase a signal-to-noise ratio of the signal from the first hair.

61. (canceled)

62. The system of claim 51, wherein the circuitry for obtaining a signal from a first hair comprises:
circuitry for identifying a time reference responsive to the signal from the first hair.

63. (canceled)

64. The system of claim 51, wherein the circuitry for obtaining a signal from a first hair comprises:
circuitry for extending the signal from the first hair.

65. The system of claim 51, wherein the circuitry for obtaining a signal from a first hair comprises:
circuitry for obtaining an indication of a removal of at least a sebum layer from a lateral surface of the first hair.

66. The system of claim 51, wherein the circuitry for obtaining a signal from a first hair comprises:
circuitry for detecting an axially-dependent variation in the first hair by detecting an emission from or via a lateral surface of the first hair.

67. The system of claim 51, wherein the circuitry for obtaining a signal from a first hair comprises:
circuitry for establishing a marker position along the first hair by detecting an impurity in a longitudinal portion of the first hair.

68. The system of claim 51, wherein the circuitry for obtaining a signal from a first hair comprises:
circuitry for establishing a marker position along the first hair by recording a transition in a longitudinal portion of the first hair.

69. The system of claim 51, wherein the circuitry for obtaining a signal from a first hair comprises:
circuitry for establishing a reference position relative to a naturally-occurring marker in the first hair.

70. The system of claim 51, wherein the circuitry for obtaining a signal from a first hair comprises:
circuitry for establishing a marker position.

71. The system of claim 51, wherein the circuitry for obtaining a signal from a first hair comprises:
circuitry for indicating a section length responsive to a time interval selection.

72. The system of claim 51, wherein the circuitry for obtaining a signal from a first hair comprises:
circuitry for indicating a section length responsive to user input.

73. The system of claim 51, wherein the circuitry for obtaining a signal from a first hair comprises:
circuitry for receiving an indication that a longitudinal feature of the first hair substantially aligns with a longitudinal feature of the second hair.

74. (canceled)

75. The system of claim 51, wherein the circuitry for obtaining a signal from a first hair comprises:
circuitry for indicating a removal of a test section of the first hair of at most about 5 micrograms per strand.
